(19) United States
(12) Patent Application Publication
(10) Pub. No.: US 2008/0028146 A1
(43) Pub. Date: Jan. 31, 2008

(54) USB flash disk device and method

(75) Inventors: Raz Dan, San Jose, CA (US); Itzhak Pomerantz, Kfar Saba (IL)

Correspondence Address: MARK M. FRIEDMAN, C/O DISCOVEY DISPATCH , 9003 FLIRIN WAY, UPPER MARLBORO, MD, 20772, US

(73) Assignee: SanDisk IL LTD.

(21) Appl. No.: 11/655,864

(22) Filed: Jan. 22, 2007

Related U.S. Application Data
(60) Provisional application No. 60/820,346, filed on Jul. 26, 2006.

(51) Int. Cl. G06F 12/00; G06F 13/00

(52) U.S. Cl. 711/115; 711/154

(57) ABSTRACT

A portable storage device includes a storage area for storing data; a first connector operative to enable access to only a first portion of the storage area; a second connector operative to enable access to only a second portion of the storage area; and a single housing that accommodates the storage area, the first connector and the second connector. An access control mechanism also controls access to the first portion of the storage area.

### CROSS-REFERENCE TO RELATED APPLICATIONS

This patent application claims the benefit of U.S. Provisional Patent Application No. 60/820,346 filed Jul. 26, 2006.

### FIELD OF THE INVENTION

The present invention relates generally to the field of data storage in USB Flash Disks.

### BACKGROUND OF THE INVENTION

USB flash disks (UFD) are well known devices in the art of computer engineering for storing and porting information from one host computer to another.

One important type of UFD are the Secured UFD's, in which the access to the stored data is protected by a password, by encryption or by biometric authentication, available from msystems Ltd., Kefar Sava, Israel.

Many UFD users use a Secured UFD device to carry information that is partially confidential and should be protected and partially public and should preferably be open to access.

Existing UFD's for serving this need include folders that are access controlled as well as folders that are open for any user, such as KeySafe™, available from msystems, Kefar Sava, Israel.

However, UFD security methods known in the art impose at least one of two limitations on the convenience of the user: Such methods either require that the authentication of the user will be done through the host computer (for example, entering a password), or that the UFD will be self-powered and will be able to execute a software program. The first requirement is risky, as the host computer may not be trusted and may be programmed to capture a password passing through it. The second requirement is problematic, as the secured UFD may become unavailable to the user if its battery is depleted.

A third limitation, in accordance with the common requirements of the information security technology, is that the sharing of confidential and non confidential information in the same flash memory is not acceptable as machine errors and human errors may cause the storage of confidential information in a non-secured area.

Prior art system and method utilizing a Secured UFD device is taught by patent application Ser. No. 11/471,565 to Baum, which discloses a system for protecting a UFD using a password, where the password is interpreted when the UFD is powered by the host computer, but the password is entered by the user prior to the insertion of the UFD to the host. The Baum application is incorporated by reference for all purposes as if fully set forth herein.

The system disclosed in the Baum application solves the first two limitations imposed by security methods known in the art, as described herein above, by using a mechanical position indicator to define a password that is checked by the UFD processor upon connection of power. However, the Baum application leaves the third limitation, regarding the sharing of confidential and non confidential information in the same flash memory, unsolved.

Thus, it would be very desirable to provide means for powerlessly securing a UFD with absolute physical separation between the secured and the non secured parts of the storage.

There is thus a widely recognized need for, and it would be highly advantageous to have, a single device and method for powerlessly securing a UFD with absolute physical separation between the secured and the non-secured parts of the storage area within the UFD, while overcoming the limitations of prior art devices.

### SUMMARY OF THE INVENTION

Accordingly, it is a principal object of the present invention to introduce a twin UFD device having a single housing for enclosing two UFD devices, while providing absolute physical separation between a secured storage area of a first UFD device and a non-secured area of a second UFD device.

In accordance with yet another embodiment, there is provided a twin UFD device having a first UFD device, a second UFD device and a connection mechanism. Each of a first and a second part of a connection mechanism, associating with the first and second UFD devices respectively, is operative to fully accommodate the other UFD device's connector. In a closed state, the two UFD devices are operationally connected to become a single unit. In an open state, each of the two UFD devices is autonomously operative to be connected to a host.

In accordance with one embodiment of the present invention, there is provided a portable storage device that includes: (a) a storage area for storing data; (b) a first connector operative to enable access to only a first portion of the storage area; (c) a second connector operative to enable access to only a second portion of the storage area; and (d) a single housing that accommodates the storage area, the first connector and the second connector.

Preferably, the portable storage device also includes an access control mechanism for controlling access to the first portion of the storage area. More preferably, the access control mechanism interacts with the second connector to provide this access. Also more preferably, the portable storage includes a cap, of the second connector, that includes at least a portion of the access control mechanism. Also more preferably, at least a portion of the access control mechanism is embedded within the portable storage device. Also more preferably, the housing includes a shell, operationally movable about the portable storage device, having at least a portion of the access control mechanism.

The access control mechanism may include a mechanical lock, wherein the mechanical lock may typically include rotating dials. Alternatively or additionally, the access control mechanism may include a mechanism, such as a dial position reader, a challenge response mechanism, a biometric sensor, etc. Also optionally, the access control mechanism includes an authentication unit for verifying an authentication key, such that the access to the first portion of the storage area is enabled conditional on the verification of a valid authentication key. Most preferably, the portable storage device includes an interface mechanism, operationally connected to the access control mechanism, which is operative to change the authentication key. The key may include an authentication identifier, such as a pre-defined combination of numbers, a unique serial number, a password, a security decryption key, a biometric signal, etc.

Preferably, at least one of the connectors includes a USB connector.

Preferably, access to at least one portion of the storage area is non-secured.

In accordance with one embodiment of the present invention, there is further provided a method of storing information that includes the steps of: (a) housing a storage area and a first and second connectors in a single common housing; (b) storing data in the storage area; (c) providing access to a first portion of the storage area, only via the first connector; and (d) providing access to a second portion of the storage area, only via the second connector.

Preferably, the method also includes the step of allowing non-secured access to the second portion of the storage area.

Preferably, the method also includes the step of controlling access to the first portion of the storage area. More preferably, the controlling is effected by steps including covering the second connector with a cap that is configured to authorize this access to the first portion when the cap is operationally connected to the second connector. Also more preferably, the controlling is effected by manipulating a movable shell about the single common housing. Also more preferably, the controlling is effected by manipulating a mechanical lock. Alternatively or additionally, the controlling is effected by manipulating rotating dials.

The controlling may be effected by using a mechanism selected from the group consisting of: a dial position reader, a challenge response mechanism, and a biometric sensor.

Alternatively or additionally, the controlling is effected by conditioning this access to the first portion of the storage area on presentation of a valid authentication key. Most preferably, the authentication key includes an authentication identifier, such as a pre-defined combination of numbers, a unique serial number, a password, a decryption key, a biometric signal, etc. Also most preferably, the method includes the step of changing the authentication key.

In accordance with one embodiment of the present invention, there is further provided a dual-portable storage system that includes: (a) a first storage device having: (i) a first connector; (ii) a first storage area; and (iii) a first housing; (b) a second storage device having: (i) a second connector; (ii) a second storage area; and (iii) a second housing; and (c) a connecting mechanism that is operative to guide the first connector into the second housing, and the second connector into the first housing upon manipulation of the dual-portable storage to its closed state.

Preferably, the closed state is effected by rotating one of the housing relative to the other housing.

Preferably, the open state is effected by operationally pulling the two storage devices from one another.

Preferably, at least one of the first and second connectors is a USB connector.

Additional features and advantages of the invention will become apparent from the following drawings and description.

### BRIEF DESCRIPTION OF THE DRAWINGS

For a better understanding of the invention with regard to the embodiments thereof, reference is made to the accompanying drawing, in which like numerals designate corresponding sections or elements throughout, and in which:

FIG. 1A is a first embodiment of a UFD device of the present invention;

FIG. 1B is the UFD device of FIG. 1A, where the bottom cap and the top cap are removed;

FIG. 2A is the UFD device of FIG. 1A, where only the top cap is removed;

FIG. 2B is the UFD device of FIG. 1A, where only the bottom cap is removed;

FIG. 3 is a second embodiment of a twin UFD device of the present invention, where the top cap serves as a mechanical lock;

FIG. 4 is a block diagram of the twin UFD of the present invention including the top cap;

FIG. 5A is another embodiment of a twin UFD device of the present invention, set to operate as an ordinary UFD;

FIG. 5B is the twin UFD device of FIG. 5A, set to operate as a secured UFD;

FIG. 6A is schematic illustration of the inner circuitry of the UFD device of FIG. 5A;

FIG. 6B is schematic illustration of the inner circuitry of the twin UFD device of FIG. 5B;

FIG. 7A is a another embodiment of a twin UFD device of the present invention;

FIG. 7B is an ordinary UFD of the twin UFD device of FIG. 7A;

FIG. 7B is a secured UFD of the twin UFD device of FIG. 7A;

FIG. 8A is a another embodiment of the twin UFD device of the present invention; and

FIG. 8B is the twin UFD device of FIG. 8A, where the two UFD's are accommodated within each other;

### DETAILED DESCRIPTION OF THE PREFERRED EMBODIMENTS

The present invention is a twin UFD device having a single housing for enclosing two UFD devices, while providing absolute physical separation between a secured storage area of a first UFD device and a non-secured area of a second UFD device. This physical separation makes it easy both for the user and for the application designer to prevent accidental confusion between the two types of secured and non-secured information.

In one preferred embodiment of the present invention, the twin UFD device includes a first UFD configured either unsecured or secured by a prior art method (defined herein “ordinary UFD”) and a second UFD is configured with means of the present invention for secure operation (defined herein “secured UFD”). Each of the secured UFD and the ordinary UFD is configured with a UFD plug connector, typically on opposite ends of the twin UFD device. The first connector is internally connected to a flash controller and a secured flash memory. The second connector is internally wired to a switch that connects alternately to the non-secure flash memory and to the authentication circuit of the secured flash memory.

Typically, a clear mark on the body of each UFD can be an indicator for distinguishing between the two connectors.

An access control mechanism refers herein to mean any mechanism providing access control of the secured memory. The access control mechanism can be implemented to include a dial position reader, a challenge response mechanism, a biometric sensor, etc. Typically, the access control mechanism is utilized for access control when plugging the second connector into a host computer.

When the twin UFD of the present invention is plugged to a host computer using the second connector, the twin UFD functions as an ordinary non-secure UFD. When the twin UFD of the present invention is plugged to a host computer using the first connector, the twin UFD functions as a secure UFD that does not provide access to the stored information unless a valid authentication key is provided to the second connector.

An authentication key is used herein in the broad sense to include any information that serves for authentication of a user. The authentication key can be a unique serial number, a password, a decryption key, biometric signals, or any other means for authenticating a user that is known in the prior art.

In another preferred embodiment of the present invention, there is no physical switch for moving between one of the above modes of operation to the other, and the switch is done logically in the electronics.

In yet another preferred embodiment of the present invention, there is also provided a connection mechanism having a first and a second part, each such connection part associating with a respective UFD device to fully accommodate a USB connector of the other UFD device. In a closed state, the two UFD devices are operationally connected to become a single unit. In an open state, each of the two UFD devices is autonomously operative for connection to a host.

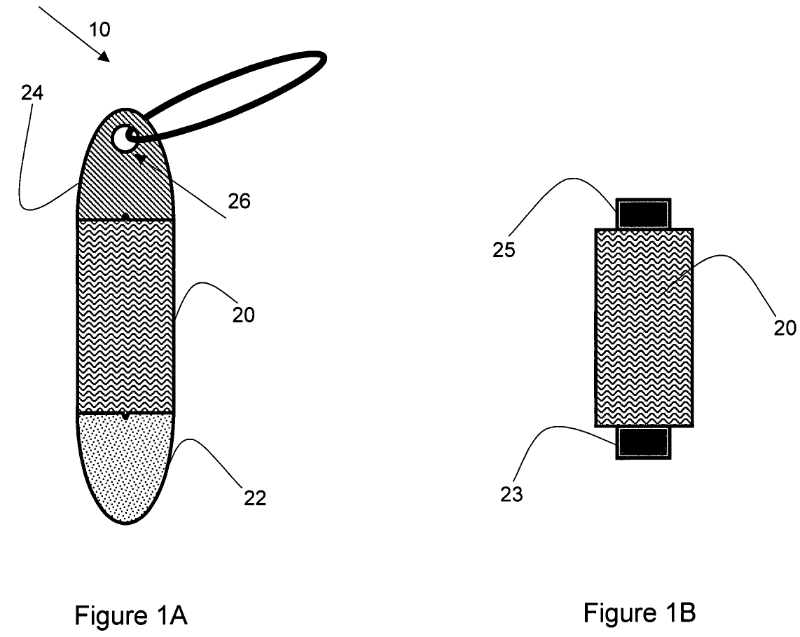

Referring now to FIG. 1A, there is shown a schematic illustration of a twin UFD device 10, where an access control mechanism is embedded within the body of the UFD device in accordance with a first embodiment of the present invention. The UFD device includes double circuitry (two controllers, two plug connectors and two flash memories). The body 20 of the UFD device is attached to the UFD device's two connectors (not shown) each covered by a corresponding caps—a bottom cap 22 and a top cap 24.

While the bottom cap 22 is only a physical protection cap, such as the plastic cap known in the art of USB devices, the top cap 24, typically including a hole 26 to allow securing the UFD device to a keychain of a user for example, serves as an access control mechanism controlling access to the secure flash memory. Configuring the top cap 24 to serve as an access control mechanism can be by means of a hard wired serial number, an electrical dial position reader (such as rotational dials attached to a variable resistor), an optical shaft encoder, or any other mechanism that can be electronically read through the USB connector upon powering up the UFD device.

The secure flash memory cannot be accessed unless the top cap 24 is connected to the top connector and a valid authentication key is provided to the UFD controller, for example by using a dial position reader or by keying a password, or by providing the correct built in serial number.

Referring to FIG. 1B, there is shown a schematic illustration of the twin UFD device of FIG. 1A, where both the top and bottom caps are removed and their corresponding connectors are exposed. The body 20 of the UFD device is attached to a top connector 25 on one end and to a bottom connector 23 on its other end.

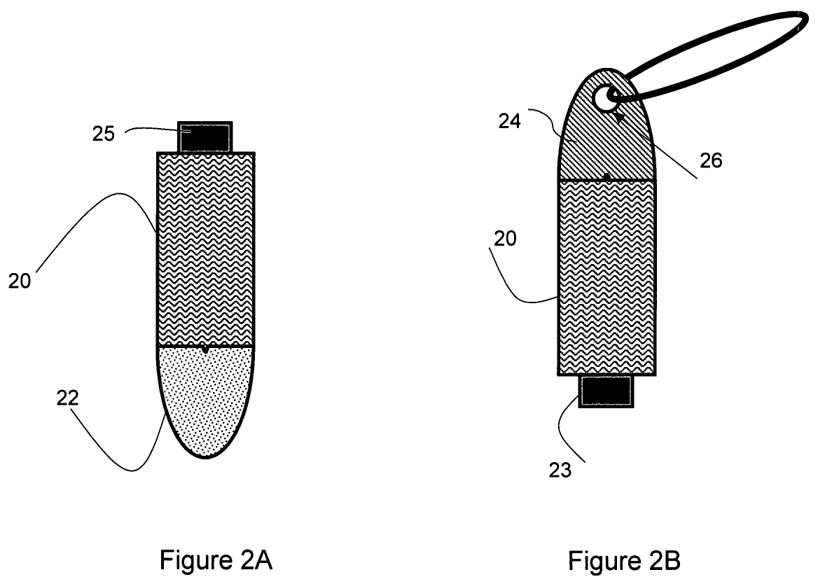

Referring to FIG. 2A, there is shown a schematic illustration of the twin UFD device of FIG. 1A, where only the top connector is exposed. The body 20 of the UFD device is attached to a top connector 25 and to a bottom connector that is covered by a bottom cap 22.

Using the UFD device as an ordinary UFD requires connecting the top connector 25 to the host computer. The bottom cap and its bottom connector are not in use in this mode.

Referring to FIG. 2B, there is shown a schematic illustration of the twin UFD device of FIG. 1, where only the bottom connector is exposed. The body 20 of the UFD device is attached to a bottom connector 23 and a top connector (covered by top cap 24 typically including a hole 26 to allow securing the UFD device to a keychain of a user for example).

Using the UFD device as a secured UFD requires positioning the top cap 24 to properly cover the top connector, such that top cap 24 functions as a valid authentication key to allow access to the secure storage area of the UFD device (when connecting bottom connector 23 to a host computer).

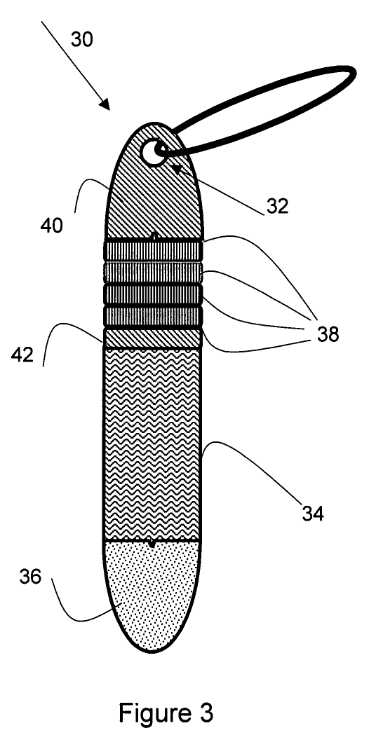

Referring now to FIG. 3, there is shown a schematic illustration of a twin UFD device 30, where an access control mechanism is configured within a top cap in accordance with a second embodiment of the present invention. The body 34 of the UFD device is attached to a bottom connector that is covered by a bottom cap 36 and a top connector that is covered by a top cap 40. The top cap 40 typically includes a hole 32 to allow securing the UFD device to a keychain of a user for example.

The top cap 40 includes rotation dials 38 that serve as an access control mechanism controlling access to the secured memory. The rotation dials 38 are marked with numbers (not shown) that are rotated by the user according to a pre-defined combination of numbers. Each dial rotates a portion of a variable resistor. The numerical combination of the dials uniquely defines the resistance of the variable resistor. Upon powering up of the UFD, the controller of the UFD reads the resistance of the resistors in the top cap and determines if the dials have been correctly positioned. If and only if the dials are correctly positioned—the controller gives the user access to the secured memory.

An extension substance 42, attached to top cap 40, is provided for keeping the rotation dials 38 in place and prevents rotation dials 38 from slipping off the top cap 40.

Using the UFD device as a secured UFD and gaining access to the secure flash memory requires rotating rotation dials 38 of the top cap 40 according to the pre-defined combination of numbers and plugging the bottom connector (that is removed from the bottom cap 36).

The rotation dials, as well as other alternative means of using the top cap as an access control mechanism, are disclosed in the Baum patent application referred to above.

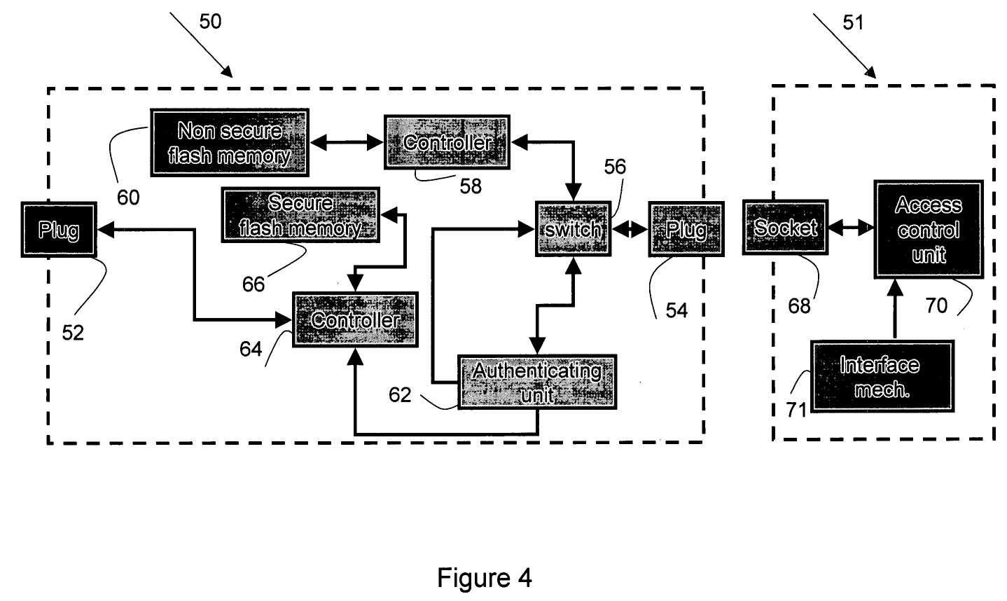

Referring to FIG. 4, there is shown a block diagram of a twin UFD device including a top cap 51, where an access control mechanism is configured within the top cap. The UFD device includes a bottom plug connector 52 and a top plug connector 54.

The top cap 51 includes a USB socket 68 and an access-control unit 70 controlling access to a secured memory 66 of the UFD device. Access-control unit 70 is implemented to include any of the authentication means mentioned above.

The top connector 54 is connected to a switch 56 capable of routing the signals of the top connector 54 to either controller 58 of a non-secured memory 60 (when using the UFD device as an ordinary UFD), or to controller 64 of the secured memory 66 via an authentication unit 62 (when using the UFD device as a secured UFD). The switch 56 can be either a physical switch or a logical switch implemented in software.

Authentication unit 62 is wired to be powered only when the bottom plug connector 52 is connected to a host computer. When bottom plug connector 52 is disconnected, the authentication unit 62 is not powered. In other words, when the top plug connector 54 is plugged to a host computer, authentication unit 62 is not powered and the UFD device operates as an ordinary, non secure UFD, providing un-restricted access to the non-secured memory 60. When the bottom plug connector 52 is plugged to the host computer, authentication unit 62 is powered and the switch 56 operates to connect the signals of top connector 54 to the authentication unit 62, thereby controlling access to the secured memory 66 using controller 64.

The authentication unit 62 monitors the signal coming from the top connector 54 and determines whether this signal includes a valid authentication key providing access to the secured memory 66. If a valid authentication key is provided, and as long as the authentication key is provided, the authentication unit 62 provides the controller 64 of the secured memory 66 with an indication that the user has been authenticated, and the controller 64 may serve the host computer connected to bottom plug connector 52 with access to the secured memory 66. If the top cap 51 is removed from top connector 54, then a valid authentication key is no more provided and authentication unit 62 instructs controller 64 to block access to the secured memory 66.

An interface mechanism 71, connected to access-control unit 70, is optionally provided to enable a user (preferably upon authentication of the user) to change the valid authentication key.

While access-control unit 70 is implemented to include any of the authentication means mentioned above, there is a special advantage in implementing access-control unit 70 and authenticating unit 62 to implement a challenge response authentication scheme, by which the authenticating unit 62 challenges the access-control unit 70 in the top cap and the access-control unit calculates a response and sends it back to the authenticating unit 62. This scheme prevents hacking by connecting a cable between the top plug connector 54 and the USB socket 68 and monitoring fixed information that are received from the access-control unit 70 in the top cap.

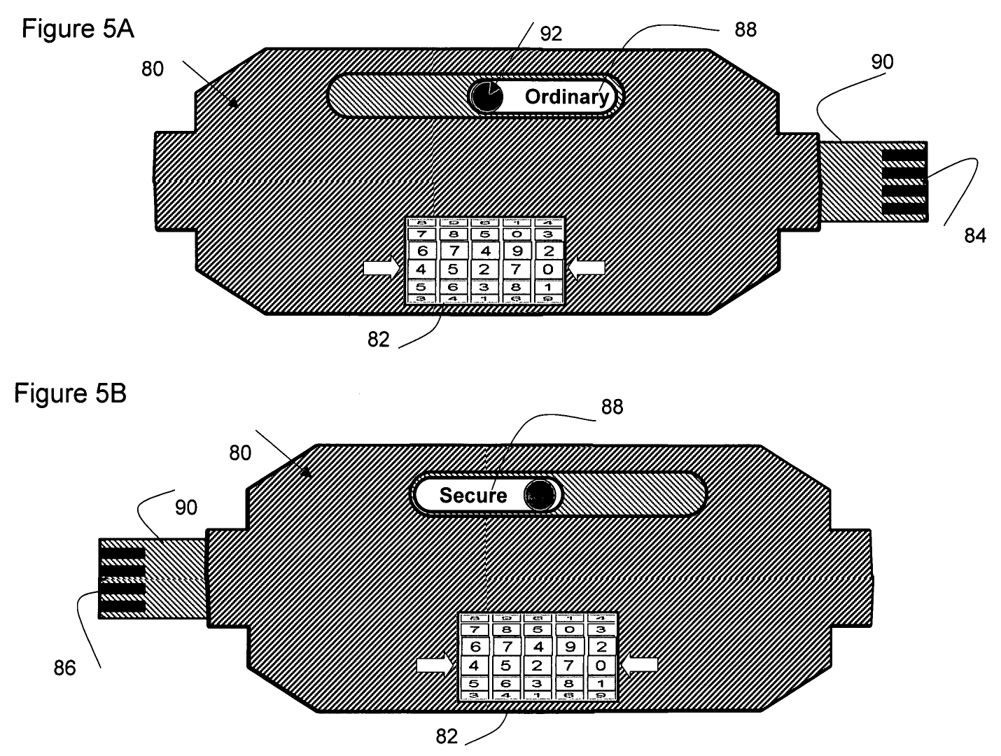

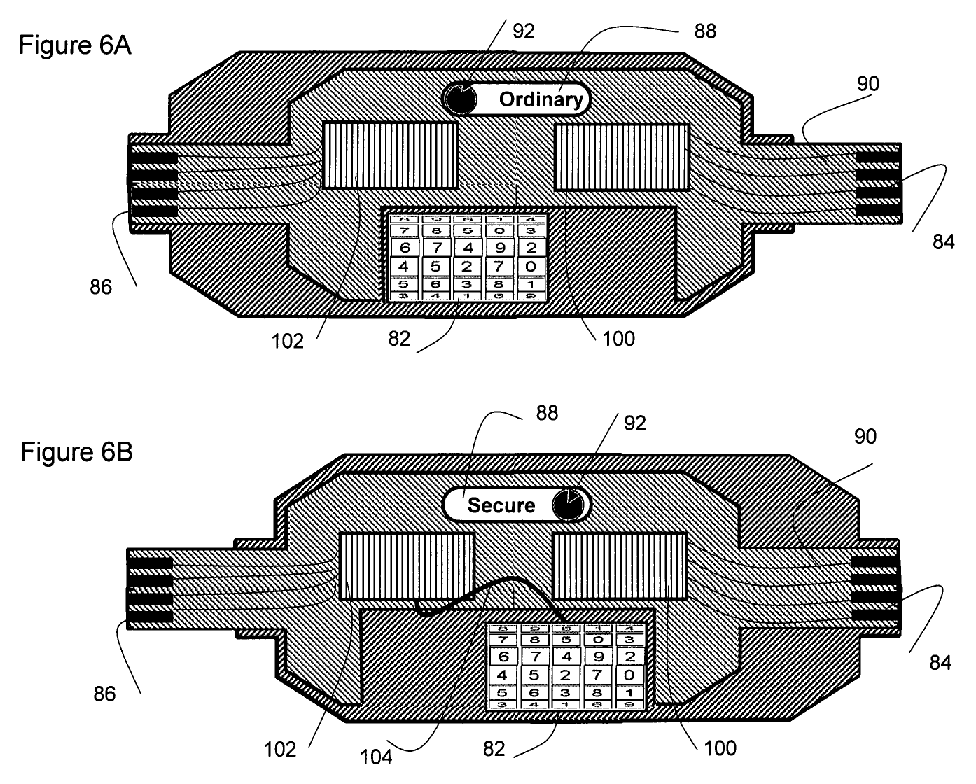

Referring to FIG. 5A, there is shown a schematic illustration of a UFD device that is set to operate as an ordinary UFD, where an access control mechanism is embedded within the body of the UFD device according to another embodiment of the present invention. In this embodiment, the shell 80 of the UFD device can slide left and right, exposing alternatively the top plug connector 84 and the bottom connector 86 of the UFD device, to operate the UFD device as an ordinary UFD or as a secured UFD respectively. A printed circuit board 90 of the UFD device is connected on either sides to the top connector 84 and to the bottom connector 86. The access control mechanism is implemented here as a dial position reader 82, such as a set of mechanical dials, that is fixed to the shell 80 of the UFD device and is wired to the electronic circuitry 102 of the secured UFD device (see FIG. 6B). A single cap (not shown) can be optionally used to cover the exposed connector—either the top connector or the bottom connector.

Also note that in this embodiment, the length of the UFD device is typically shorter than the length of the UFD device that is configured according to the first embodiment (where the access control mechanism is configured within the top cap in), as there is no need to provide two different caps to protect the two plug connectors.

In FIG. 5A the shell 80 of the UFD device is manipulated left to cover the bottom connector, thereby exposing the top connector 84 and operating the UFD device as an ordinary UFD. A slot 88 in the printed circuit board 90 exposes the label “Ordinary”, in accordance with the position of the PCB relative to the shell (see FIG. 6A), to indicate that the UFD device operates as an ordinary IFD. A pin 92, fixed to the bottom of the shell limits the motion of the printed circuit board 90. The dial position reader 82 remains unused when operating the UFD device as an ordinary UFD.

Referring to FIG. 5B, there is shown a schematic illustration of the UFD device of FIG. 5A that is set to operate as a secured UFD. In FIG. 5B the shell 80 of the UFD device is manipulated right to cover the top connector, thereby exposing the bottom connector 84 and operating the UFD device as a secured UFD. A slot 88 in the printed circuit board 90 exposes the label “Secured”, in accordance with the position of the PCB relative to the shell (see FIG. 6B), to indicate that the UFD device operates as a secured IFD. A pin 92, fixed to the bottom of the shell limits the motion of the printed circuit board 90. The dial position reader 82 must be set to the valid authentication key when operating the UFD device as a secured UFD. For example, if the dial position reader includes a set of multiple mechanical dials, the dials must be manipulated by the user to achieve the value pre-defined by the valid authentication key.

Referring to FIG. 6A, there is shown a schematic illustration of the inner circuitry of the UFD device of FIG. 5A. The printed circuit board 90 is now fully exposed, showing an electronic circuitry 100 of the ordinary UFD device and an electronic circuitry 102 of the secured UFD device connected to the top connector 84 and the bottom connector 86 respectively.

Referring to FIG. 6B, there is shown a schematic illustration of the inner circuitry of the UFD device of FIG. 5B. A flexible cable 104 connects the dial position reader indicator 82 to the electronic circuitry 102 of the secured UFD device.

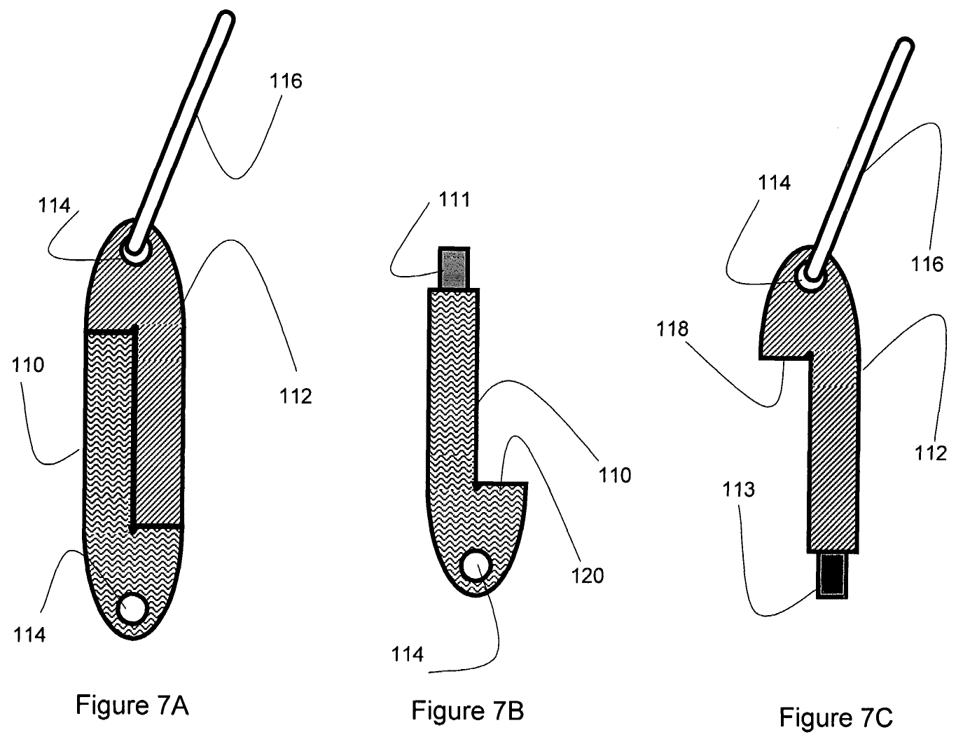

Referring now to FIG. 7A, there is shown a schematic illustration of a twin UFD device including two different UFD devices, in accordance with another embodiment of the present invention.

Preferably, the first UFD device is an ordinary UFD 110 and the second UFD device is a secured UFD 112 configured with an access-controlled mechanism, as described above.

The twin UFD device includes an ordinary UFD 110 having a top connector 111 (see FIG. 7B) that is plugged to a bottom connector 113 of a secured UFD 112 (see FIG. 7C). The secured UFD is configured by any of the prior art software based methods to be used as a secure UFD, such as Xkey™, available from msystems Ltd., Kefar Sava, Israel and is optionally painted in a color that distinguishes the secured UFD from the color of the ordinary UFD.

The assembly of the twin UFD of FIG. 7A into one portable object has a lot of advantages for the user. Typically, the secured UFD is linked to a keychain of a user and is therefore better secured than the ordinary UFD. The user can hand over the ordinary UFD to others, while keeping the secured UFD for himself/herself to used as backup, for example. In case that a double volume of storage is required, both UFD's can be plugged into a same host computer and a software program can split the content between the ordinary UFD and the secured UFD, using the UFD's cumulative storage volume. For example, if the user has some personal files and some work files that are varying from one day to another, he/she can keep one secured UFD and several ordinary UFD's, each storing different information, while plugging any ordinary UFD's to the secured UFD upon request. As such, the personal files are always available, while the work files are changing according to the user's needs.

Referring to FIG. 7B, there is shown a schematic illustration of the ordinary UFD 110 of the twin UFD device of FIG. 7A. The ordinary UFD 110 includes a top connector 111 and an extension of its housing 120 provided to accommodate an extension housing 118 and a bottom connector of the secured UFD (see FIG. 7C) respectively. A hole 114 can be optionally used to tie the ordinary UFD 110 to a key chain.

Referring to FIG. 7C, there is shown a schematic illustration of the secured UFD of the twin UFD device of FIG. 7A. The secured UFD 112 includes a bottom connector 113 and a housing extension 118 (of this secured UFD 112) is provided to accommodate a housing extension 120 and a bottom connector of the secured UFD 110 (see FIG. 7B) respectively. A hole 114 can be optionally used to tie the secured UFD 112 to a key chain 116.

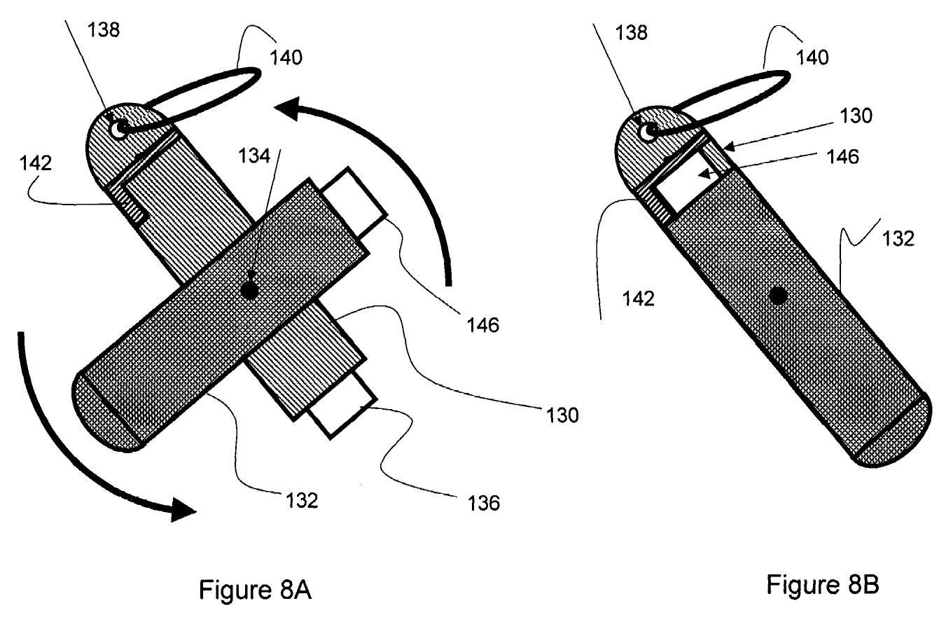

Referring to FIG. 8A, there is shown another embodiment of the twin UFD device of the present invention. The twin UFD device includes a first UFD 130 that is connected with an axial pivot 134 to a second UFD 132. One of the two UFD's can be configured as a secured UFD for secure operation, while the other can be configured as an ordinary UFD for ordinary operation, thus providing a twin UFD configured with two UFD's on the same device with complete physical separation between the secure and the non secure devices.

UFD 130 includes a USB connector 136 and typically a hole 138 at the top for connecting UFD 130 to a key chain 140. A protrusion 142 extending from the planar surface of UFD 130 is dimensioned and positioned to accommodate USB connector 146 of UFD 132. A corresponding protrusion (not shown) is configured upon UFD 132 as well to accommodate USB connector 136 of UFD 130.

UFD 132 is connected to UFD 130 with the axial pivot 134, so that a flat surface of UFD 130 is co-planar with a flat surface of UFD 132. When UFD 132 is rotated counterclockwise around axial pivot 134, USB connectors 146 and 136 enter the accommodating rest place of the protrusions of USB 130 and USB 132 respectively (see FIG. 8B).

Note that each of the two connectors can be alternately plugged into a USB socket for functional operation by rotating UFD 132 clockwise.

Referring to FIG. 8B, there is shown the twin UFD device of FIG. 8A, where USB connectors 136 and 146 are accommodated within the protrusions of USB 132 and USB 130 respectively.

Furthermore it can be understood that other devices are possible within the scope of the invention, thus relating to any connecting device having two USB plug connectors, where each of the two plug connectors provides access to at least a portion of the storage embedded within the UFD. Preferably, but not necessarily, access through one of the plugs is secure while access through the other plug is not secure.

Having described the invention with regard to certain specific embodiments thereof, it is to be understood that the description is not meant as a limitation, since further modifications will now suggest themselves to those skilled in the art, and it is intended to cover such modifications as fall within the scope of the appended claims.

1. A portable storage device comprising:
(a) a storage area for storing data;
(b) a first connector operative to enable access to only a first portion of said storage area;
(c) a second connector operative to enable access to only a second portion of said storage area; and
(d) a single housing that accommodates said storage area, said first connector and said second connector.

2. The portable storage device of claim 1 further comprising:
(b) an access control mechanism for controlling access to said first portion of said storage area.

3. The portable storage device of claim 2, wherein said access control mechanism interacts with said second connector to provide said access.

4. The portable storage device of claim 2 further comprising:
(c) a cap, of said second connector, that includes at least a portion of said access control mechanism.

5. The portable storage device of claim 2, wherein at least a portion of said access control mechanism is embedded within the portable storage device.

6. The portable storage device of claim 2, wherein said housing includes a shell, operationally movable about the portable storage device, having at least a portion of said access control mechanism.

7. The portable storage device of claim 2, wherein said access control mechanism includes a mechanical lock.

8. The portable storage device of claim 7, where said mechanical lock includes rotating dials.

9. The portable storage device of claim 2, wherein said access control mechanism includes a mechanism selected from the group consisting of: a dial position reader, a challenge response mechanism, and a biometric sensor.

10. The portable storage device of claim 2, wherein said access control mechanism includes an authentication unit for verifying an authentication key, such that said access to said first portion of said storage area is enabled conditional on said verification of a valid said authentication key.

11. The portable storage device of claim 10 further comprising:
(c) an interface mechanism, operationally connected to said access control mechanism, that is operative to change said authentication key.

12. The portable storage device of claim 10, wherein said authentication key includes an authentication identifier selected from the group consisting of: a pre-defined combination of numbers, a unique serial number, a password, a security decryption key, and a biometric signal.

13. The portable storage device of claim 1, wherein at least one of said first connector and said second connector includes a USB connector.

14. The portable storage device of claim 1, wherein said access to at least one of said first portion and said second portion of said storage area is non-secured.

15. A method of storing information, the method comprising the steps of:
(a) housing a storage area and a first and second connectors in a single common housing;
(b) storing data in said storage area;
(c) providing access to a first portion of said storage area, only via said first connector; and
(d) providing access to a second portion of said storage area, only via said second connector.

16. The method of claim 15 further comprising the step of:
(e) allowing non-secured access to said second portion of said storage area.

17. The method of claim 15 further comprising the step of:
(e) controlling access to said first portion of said storage area.

18. The method of claim 17, wherein said controlling is effected by steps including covering said second connector with a cap that is configured to authorize said access to said first portion when said cap is operationally connected to said second connector.

19. The method of claim 17, wherein said controlling is effected by manipulating a movable shell about the single common housing.

20. The method of claim 17, wherein said controlling is effected by manipulating a mechanical lock.

21. The method of claim 17, wherein said controlling is effected by manipulating rotating dials.

22. The method of claim 17, wherein said controlling is effected by using a mechanism selected from the group consisting of: a dial position reader, a challenge response mechanism, and a biometric sensor.

23. The method of claim 17, wherein said controlling is effected by conditioning said access to said first portion of said storage area on presentation of a valid authentication key.

24. The method of claim 23, wherein said authentication key includes an authentication identifier selected from the group consisting of: a pre-defined combination of numbers, a unique serial number, a password, a decryption key, and a biometric signal.

25. The method of claim 23 further comprising:
(f) changing said authentication key.

26. A dual-portable storage system comprising:
(a) a first storage device including:
(i) a first connector;
(ii) a first storage area; and
(iii) a first housing;
(b) a second storage device including:
(i) a second connector;
(ii) a second storage area; and
(iii) a second housing; and
(c) a connecting mechanism operative to guide said first connector into said second housing, and said second connector into said first housing upon manipulation of the dual-portable storage to its closed state.

27. The dual-portable storage device of claim 26, wherein said closed state is effected by rotating one of said housing relative to other said housing.

28. The dual-portable storage device of claim 26, wherein said open state is effected by operationally pulling said storage devices from one another.

29. The dual-portable storage device of claim 26, wherein at least one of said first and second connectors is a USB connector.
